(19) United States
(12) Patent Application Publication
(10) Pub. No.: US 2011/0121484 A1
(43) Pub. Date: May 26, 2011

(54) Method of producing a color enhanced surface seeded exposed aggregate concrete

(76) Inventor: Mike Gunther, Orange, CA (US)

(21) Appl. No.: 12/927,628

(22) Filed: Nov. 19, 2010

Related U.S. Application Data
(60) Provisional application No. 61/281,982, filed on Nov. 25, 2009.

(51) Int. Cl. B28B 11/06; B28B 11/08

(52) U.S. Cl. 264/162

(57) ABSTRACT

An improved method is provided for producing a color enhanced surface seeded exposed aggregate concrete. The method includes preparing a subgrade or framework for receipt of a concrete mixture. Fill sand and/or rebar may be utilized for structural strength. A concrete mixture is poured over the subgrade. The surface of the concrete is floated or screeded to an appropriate slope. A color hardener is applied to the concrete surface to create a colorized concrete surface. The color hardener is troweled to provide uniformity of color. An aggregate is broadcast into the colorized concrete surface and than troweled to fully embed the aggregate in place. The aggregate is then exposed utilizing a chemical retardant or mechanical apparatus. Thereafter, preferably the color enhanced surface seeded exposed aggregate surface is washed and sealed.

### RELATED APPLICATIONS

The present application is a continuation-in-part application to co-pending U.S. Provisional Application No. 61/281,982 filed on Nov. 25, 2009.

### BACKGROUND OF THE INVENTION

The present invention relates to concrete construction, and more particularly to methods for producing concrete constructions. Even more particularly, the present invention relates to surface seeded aggregate concrete.

Concrete is a well known building material for commercial and residential applications. Concrete is durable has good weight resistance and excellence cost economy. Recently, concrete has become used more and more for both flooring applications, but also for other structural applications which are highly visible to the public. Because of its widespread use, it is desirable to provide different color and surface textures for the concrete. Well known techniques for improving aesthetics include adding color to the concrete. Other aesthetic techniques include modifying the surface texture of the concrete by imploring various finishes.

Still an additional attempt to improve the aesthetics of concrete is to provide an aggregate finish. A first method of preparing an aggregate finish produces “integrally mixed aggregate concrete”. The integrally mixed aggregate concrete is prepared by integrating aggregates throughout the concrete flab. Thereafter, surface cement and finds are washed or removed from the concrete while the concrete surface is still in a plastic state so that the aggregate (such as stone, gravel or glass) is left exposed on the surface of the concrete. Alternatively, a topical surface retardant is applied so as to allow the top layer of the concrete to be removed. The normal size of the aggregate is typically less than 1.5 inch in mean diameter.

More recently, a surface seeded exposed aggregate method has been introduced. In this particular method, subsequent to pouring of the concrete, an aggregate is broadcast (also referred to as “seeded”) over the top surface of the concrete. Thereafter, the aggregate is troweled into the concrete so as to form a planar concrete upper surface. With the curing of the concrete, the previously broadcast aggregate is affixed in place but otherwise exposed. Preferably, the aggregate is nominally about 0.5 inch in diameter or less mean size such that the aggregate can be worked into the top surface and adequately affixed in place.

Several patents have been filed to surface seeded exposed aggregate concrete. U.S. Pat. No. 4,748,788 describes a method of creating a surface seeded aggregate concrete wherein aggregate is broadcast into a concrete surface. A surface retardant vapor barrier is applied and a surface retardant is sprayed upon and washed from the surface. U.S. Pat. Nos. 7,322,772 and 7,607,859 describe methods for producing a surface seeded aggregate concrete which is intended to simulate quarried stone. Allegedly, the methods described in these patents provide improved aesthetics. Still additional U.S. Pat. No. 7,614,820 describes a method for producing a non-slick surface seeded aggregate concrete. Thus, numerous attempts have been made to create surface seeded aggregate concrete with a variety of characteristics including improved aesthetics.

Unfortunately, the various prior art surface seeded aggregate concrete surfaces are still relatively aesthetically bland. In particular, surface seeded aggregate concrete has the appearance of its description. Mainly, it appears to be a relatively bland concrete with aggregates appearing haphazardly, or uniformly throughout the concrete matrix.

Thus, there is a significant need for an improved surface seeded aggregate concrete which has improved aesthetics.

### SUMMARY OF THE INVENTION

The present invention addresses the aforementioned disadvantages by providing an improved method of producing a color enhanced surface seeded exposed aggregate concrete. The first step comprises preparing a subgrade or framework for concrete placement. The term subgrade is to be interpreted broadly to include the preparation of the ground or introduction of a steel pan for placement of concrete. A concrete mixture, preferably consisting of at least 5.5 sacks of cement content per cubic yard, is poured over the subgrade to a desired concrete slab thickness. It is preferred that the concrete not include admixtures of calcium chlorides.

After pouring of the concrete, but while the concrete is in a plastic state, the surface of the concrete is then “floated” utilizing steel, aluminum, wood, fiber glass or magnesium bull-float tools. Preferably, the concrete's surface is checked for Americans with Disabilities Act (ADA) compliance. Where the concrete pour has a large square footage, various screeds, such as laser screeds, roller screeds, Texas screeds, vibratory floats, or troweling machines may be utilized to modify the concrete's surface.

Importantly, after the concrete surface has been floated or screeded to a desired uniform and consolidated condition, a color hardener is applied to the concrete upper surface. Preferably, the color hardener is applied to concrete's surface in accordance with the manufacture's recommendations and instructions specific to the particular color hardener product. Most typical color hardeners acquire 0.6-1.0 lbs. of color hardener per square foot of exposed concrete. Preferred color hardeners include Floric Polytech Vibrant Color Hardeners. Alternative preferred colored hardeners are available from L.M. Scofield and Davis Colors. Still additional color hardeners may be selected by those skilled in the art as applicable for particular color and hardening conditions.

After the color hardener is applied to the plastic concrete surface, the concrete surface is then re-troweled. Troweling of the concrete surface is performed to work the color hardener into the concrete upper surface so as to create a substantially homogeneous colorized concrete upper surface. Again, preferably the concrete surface is examined for ADA tolerance and code compliance.

Subsequent to the troweling of the color hardener into the concrete surface, but while the concrete surface is still in a plastic state, selected aggregates are then broadcast onto the surface of the concrete. The aggregates may be of any type as can be selected by those skilled in the art such as glass, seashells, stone materials, metals, etc. As explained in greater detail below, a preferred aggregate is a colorized semi-translucent glass. Furthermore, the aggregate may be broadcast utilizing a variety of broadcasting methods including hand seeding, mechanically broadcasting or pneumatically distributing the aggregates to a desired concentration per square footage. The seeded aggregates may, or may not, be the same color as the hardener that has been previously applied to the concrete surface. However, it has been found that where the color hardener and the aggregate color are substantially the same, that the concrete appearance has an unexpected visual appeal far greater than would be expected.

Once the aggregate has been broadcast to a desired coverage, the concrete surface is again re-troweled to fully seed and work the aggregate into the concrete slab to insure full embedment of the aggregate into the concrete. At this point, an additional color hardener may be applied and re-troweled and floated into the concrete in the event that the initial step of color hardener application resulted in nonuniform areas of color in a concrete surface finish.

Thereafter, the aggregate is exposed within the colorized concrete upper surface. Exposure of the aggregate can be accomplished by a variety of processes known by the those skilled in the art such as utilizing a concrete surface retardant in accordance with the manufacture's recommendations and instructions. Alternatively, the aggregate can be exposed within the colorized concrete upper surface by utilizing abrasive mechanical apparatus such as brushes, sponges, rotary for machines or media blasting (such as sand blasting) to remove the upper layer of the concrete upper surface. When employing mechanical apparatus to expose the aggregate, an acid solution may be employed to remove the upper portion of the concrete to expose the seeded aggregate. Once the aggregate has been exposed, preferably the upper concrete surface is washed to remove any surface contaminants. The concrete surface is allowed to dry. Preferably, a suitable concrete sealant is applied to seal the colorized surface seeded exposed aggregate surface. If desirable, an anti-slip additive may be added to the sealant mixture.

Advantageously, the colorized surface seeded concrete of the present invention can be used for a wide variety of applications including horizontal applications such as walkways, but it can also be utilized for vertical applications such as walls, seat-walls, water fixtures, etc.

Advantageously, the colorized surface seeded aggregate surface provides improved aesthetics compared with any other previously developed concrete surfaces.

The use and other features and advantages of the present invention will be appreciated by those skilled in the art from the following detailed description taken in conjunction with the drawings.

### DETAILED DESCRIPTION OF THE DRAWINGS

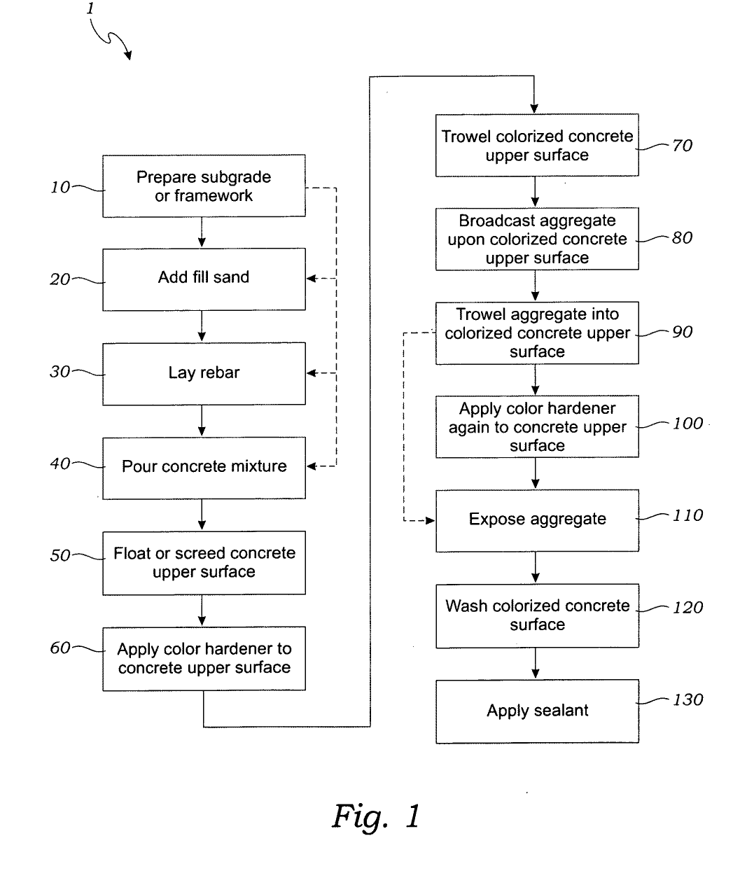

FIG. 1 is a schematic flow diagram of the steps utilized in producing the color enhanced surface seeded aggregate concrete surface of the present invention; and

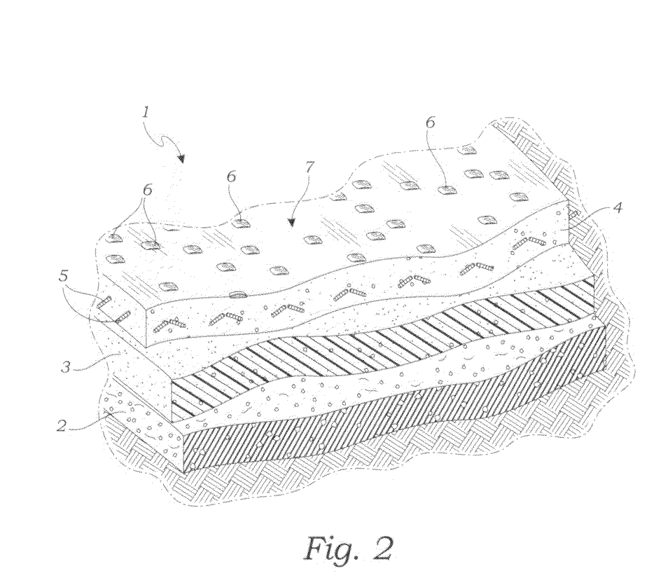

FIG. 2 is a cross-sectional view of a the various layers of the color enhanced surface seeded aggregate concrete surface of the present invention.

### DETAILED DESCRIPTION OF THE INVENTION

With reference to FIGS. 1 and 2, the method of producing a color enhanced surface seeded exposed aggregate concrete 1 comprises the initial step 10 of preparing a subgrade or framework for concrete placement. It is envisioned that the present invention will most often require the preparation of a subgrade 2 for creating substantially horizontal surfaces such as for walkways, driveways and the like. However, the present invention has application for producing substantially vertical concrete surfaces such as walls, signs, seat-walls, water fixtures etc. Where a vertical concrete construction is required, a traditional framework utilizing wood, steel or other materials is assembled to create an envelope for the receipt of a concrete mixture. The term framework, also commonly referred to as form work, is intended to be interpreted broadly to also include steel pans or the like. A typical subgrade 2 is prepared to a desired innovation and grade. Preferably, the subgrade is compacted to a desired compaction, such as a 90% compaction. Thereafter, the subgrade 2 is preferably covered with a layer of fill sand 3. It is also preferred that the reinforcement members 5 be introduced into and/or upon the subgrade 2 and fill sand 3, such as the introduction of wire mesh or rebar or the like, so as to increase the resulted strength of the concrete slab. As illustrated in FIG. 1, the addition of fill sand 20 and introduction of reinforcement members 30 are considered optional steps in the process of creating a color enhanced surface seeded aggregate surface of the present invention.

Once the reinforcement members 5 are positioned in place, a concrete mixture 4 is poured 40 over the prepared subgrade 2 or within the constructed framework to a desired concrete slab thickness. Any type of concrete mixture as can be selected by one skilled in the art may be utilized. However, it is preferred that the concrete mixture consist of at least 5.5 sacks of cement content per cubic yard or contain more than 3% air entrapment. Though color additives may be introduced into the concrete mixture, such color additives are considered unnecessary, and thus preferably, no color additives are introduced into the concrete mixture. Also preferably, the concrete mixture does not contain any calcium chlorides.

Notably, prior to the next step of preparing a color enhanced surface seeded exposed aggregate concrete of the present invention, preferably any removable framework is removed. Preferably, the concrete framework should be taken down approximately three hours after a ready mix of concrete has left a supplier plant. This three hour time frame is intended as a guideline, and the time may need to be increased or decreased depending on the concrete mix utilized, whether admixtures are introduced, and ambient air temperature. For example, the three hour time line assumes ambient temperature at approximately 60°-80°. However, more time will be required where temperatures are below this range, and less time may be required for temperatures above this range. However, as would be understood by those skilled in the art, sufficient time must pass for the concrete to gather enough strength so as to be self supportive and stand as a structure when the framework is removed.

With reference to FIG. 1, after the concrete mixture has been poured 40 so as to create a concrete slab of a desired thickness, preferably the concrete surface is “floated” or “screed” 50 to a desired level plane or grade. Preferably, the surface of the concrete is floated utilizing steel, aluminum, wood, fiber glass, or magnesium concrete bull-float tools. Where the concrete slab has a large square footage, the use of hand floats may be abandoned and instead more efficient screeds including laser screeds, roller screeds, Texas screeds, vibratory floats, manually pushed or motored troweling finishing machines may be utilized to finish the concrete surface.

After the concrete surface has been prepared by floating or screeding, but while the concrete is still in a substantially plastic state, a color hardener is applied 60 to the concrete surface. Suitable color hardeners may be selected by those skilled in the art. Preferred color hardeners include Floric Polytech Vibrant Color Hardeners, and those color hardeners from L.M. Scofield and Davis Colors. It is preferred that the color hardener be applied in accordance with the recommendations and instructions of the manufacturer of the color hardener. However, typically 0.6-1.0 lbs. of color hardener will be required per square foot of exposed concrete.

Once the color hardener is applied 60, the concrete surface is again re-troweled 70 to work the color hardener into the concrete surface while it is still in a plastic state. The troweling 70 of the concrete is intended to create a substantially homogeneous colorized concrete surface 7 (shown in FIG. 2) having a substantially uniform finish once the step of troweling 70 has been complete. Once troweled, it is preferred that the colorized concrete surface 7 be once again checked for ADA tolerance and code compliance.

While the colorized concrete surface is still in a plastic state, a quantity of aggregate 6 is broadcast 80 onto the colorized concrete surface until the coverage of aggregate is uniform to a desired ratio of aggregate to concrete. Various aggregates may be utilized such as coarse sand, glass chips, organic material such as seashells, metals or composite materials. It is preferred that the aggregate is typically less than 0.5 inch in mean diameter.

After the aggregate has been broadcast upon the colorized concrete surface 80, the surface is again re-troweled 90 to fully seat and work the aggregate 6 into the concrete slab to create a uniform and homogenized surface 7 with full embedment of the aggregate into the concrete. As illustrated in FIG. 1, an additional application of color hardener may optionally be applied 100 to the concrete upper surface after the aggregate has become embedded to provide better uniformity of color in the event that the previous steps resulted in the concrete surface finish having non-uniform areas of color.

As illustrated in step 110 of FIG. 1, once all applications of color hardener and introduction of aggregate has been completed, the colorized concrete surface is exposed. Exposure may be accomplished utilizing either surface retardants or mechanical exposure methods known to those skilled in the art. When utilizing a concrete surface retardant, a surface retardant such as Grace Construction Top-Cast is applied in accordance with manufacturer's specifications to the colorized concrete surface 7. Once the retardant has dried, which typically requires one to two hours, the retardant is removed utilizing water, typically by using a pressure washer. As the surface retardant is removed, the retardant removes the upper layer of the concrete slab to expose the seeded concrete in a consistent fashion. The removal of the surface retardant and upper layer of concrete leaves a colorized decorative concrete finish.

As an alternative to utilizing a concrete surface retardant to expose the aggregate 110, mechanical exposure may be accomplished utilizing brushes, sponges, rotary floor machines with abrasive pads, handheld power tools with abrasive pads, or media blasting such as sand blasting. Mechanical exposure may include application of an acid solution to remove the upper portion of the concrete to expose the seeded aggregate. Like the method utilizing a concrete surface retardant, the mechanical exposure methods remove an upper layer of the concrete slab. Advantageously, mechanical exposure methods can be utilized both the same day of concrete placement or in subsequent days after the concrete has hardened.

After exposure of the colorized concrete surface, surface contaminants are removed by washing the colorized concrete surface 120 utilizing a pressure washer, hose, scrub brushes, floor cleaning machines, etc. Preferably, the surface is then allowed to dry overnight and a sealant is applied 130 to the concrete. Various concrete sealants can be selected and utilized as can be determined by those skilled in the art in order to seal the colorized surface seeded concrete surface so as to protect it from the elements including weather and traffic. A preferred sealant includes Floric Polytech CS-101 which is a single component solvent acrylic based sealant. Water based sealants can also be utilized in environmentally sensitive areas. It is preferred that the sealant be applied 130 utilizing sprayers in accordance with manufacturer's recommendations. Typically, a sealant is applied utilizing an airless high volume low pressure (HVLP) sprayer or roller or the like. It is preferred that adjacent surfaces be protected against over-spray and that the sealant be applied at a rate of approximately 250 square feet per gallon. Ant-slip additives may also be added to the sealant mixture if an increase in the coefficient of friction is desired or acquired for ADA code compliance.

Various modifications may be made within the scope of the invention. Furthermore, the invention encompasses an almost unlimited variety of embodiments. For example, a wide variety of colors for the color hardener may be employed to colorize the concrete surface. Moreover, there is a wide variety of aggregates that may be utilized also having a wide variety of colors. Depending on aesthetic desirability, the concrete may be colorized to contrast with the exposed aggregate. Conversely, it has been found that the utilization of a color hardener having substantially the same color as the aggregate provides color vibrancy previously unknown. The combination of a partially translucent colorized glass chip aggregate with a color hardener of a substantially the same or similar color creates a concrete surface having a relatively homogenized appearance which as a vibrancy typically unknown for concrete. As but one example, the combination of a partially translucent red glass with a red color hardener possess a vibrancy typically found only upon the application of a paint or the like.

Still additional modifications of the invention may be required for creating vertical concrete surfaces. For vertical surfaces, it may be desirable to combine the broadcasting of aggregate 80 and the application of the color hardener 100 by creating a premix of the color hardener and aggregate with additional water to create a concrete-like paste. The color hardener aggregate is then applied together to the concrete surface while the concrete surface is still plastic so as to allow the paste of color hardener aggregate and water to adequately adhere to the concrete slab. Again, an additional re-application of color hardener may be applied and then troweled into the concrete's colorized surface.

While several particular forms of the invention have been illustrated and described, it will be apparent that various modifications can be made without departing from the spirit and scope of the invention. Therefore, it is not intended that the invention be limited except by the following claims. Having described my invention in such terms as to enable a person skilled in the art to understand the invention we create the invention, and practice it, and having presently identified the presently preferred embodiment thereof,

I claim:

1. A method of producing a color enhanced surface seeded exposed aggregate concrete, the method comprising the steps of:
(a) preparing a subgrade or framework for concrete placement;
(b) pouring a concrete mixture upon subgrade or within framework to create an exposed concrete surface;
(c) floating or screeding the concrete surface utilizing bull floats or screeds so that the concrete surface is consolidated and uniform, while in a plastic state;
(d) applying a colorized hardener to the concrete surface;
(e) troweling the concrete surface to work the color hardener into the concrete surface to create a substantially homogeneous colorized concrete surface;
(f) broadcasting an aggregate upon the colorized concrete surface;
(g) troweling the aggregate into the colorized concrete surface; and
(h) exposing the aggregate within the colorized concrete surface by either (1) applying a concrete surface retardant, allowing the retardant to retard hardening of an layer of the concrete, and washing away the surface retardant with water, or (2) mechanically exposing the aggregates utilizing abrasive mechanical apparatus to remove an layer of the concrete surface.

2. A method of producing a color enhanced surface seeded exposed aggregate concrete of claim 1 further comprising the steps of:
(I) applying a sealant to the colorized concrete surface to seal the exposed colorized concrete surface.

3. A method of producing a color enhanced surface seeded exposed aggregate concrete of claim 1 wherein step (f) comprises broadcasting a quantity of glass chips upon the colorized concrete surface.

4. A method of producing a color enhanced surface seeded exposed aggregate concrete of claim 3 wherein step (f) comprises broadcasting a quantity of a colorized partially translucent glass chips upon the colorized concrete.

5. A method of producing a color enhanced surface seeded exposed aggregate concrete of claim 4 wherein the color of the colorized partially translucent glass chips is substantially the same color as the color of the colorized hardener.

6. A method of producing a color enhanced surface seeded exposed aggregate concrete of claim 1 wherein steps (d) and (f) are performed contemporaneously by mixing a color hardener, aggregate and water together to form a paste and applying the paste to the concrete surface.

7. A method of producing a color enhanced surface seeded exposed aggregate concrete of claim 6 wherein step (f) comprises broadcasting a quantity of a colorized partially translucent glass chips upon the colorized concrete.

8. A method of producing a color enhanced surface seeded exposed aggregate concrete of claim 7 wherein the color of the colorized partially translucent glass chips is substantially the same color as the color of the colorized hardener.
